(19) United States
(12) Patent Application Publication
(10) Pub. No.: US 2002/0092880 A1
(43) Pub. Date: Jul. 18, 2002

(54) Dispenser package for fluent products and method of manufacture

(76) Inventors: Craig E. McClean, Harrisonburg, VA (US); Robert E. Harman, Perrysburg, OH (US)

Correspondence Address: Howard G. Bruss, Esq., 25-LDP, Owens-Illinois, Inc., Intellectual Property Department, One SeaGate, Toleo, OH, 43666, US

(21) Appl. No.: 10/095,167

(22) Filed: Mar. 11, 2002

Related U.S. Application Data
(62) Division of application No. 09/383,165, filed on Aug. 24, 1999, now Pat. No. 6,394,323.

(51) Int. Cl. B67D 3/00

(52) U.S. Cl. 222/556

(57) ABSTRACT

A dispenser package for a fluent product that includes a plastic container having an axially extending cylindrical neck, and a closure secured to the open end of the neck. The closure includes a plastic fitment having a dispensing opening and a cylindrical wall received within the neck. The container neck has a radially opening circumferential channel, while the fitment has a radially projecting circumferential bead received by snap fit into the channel to secure the fitment to the neck. A top is pivotally secured to the fitment or to the container neck for selectively opening and closing the dispensing opening. In the preferred embodiments of the invention, the dispensing opening is circular, and the top has an annular wall that forms a plug seal within the dispensing opening when the top is in the closed position. The top is flush with the fitment or the axial end of the container neck in the closed position to form a compact visual structure.

This application is a division of application Ser. No. 09/383,165 filed Aug. 24, 1999.

The present invention is directed to dispenser packages for fluent products such as cosmetics and body lotions, and more particularly to a dispenser package and method of manufacture in which the dispensing closure is closely integrated in contour and structure with the package container.

### BACKGROUND AND SUMMARY OF THE INVENTION

It is a general object of the present invention to provide a dispenser package and method of manufacture for fluent products, such as cosmetics and body lotions, which obtain reduced manufacturing and inventory cost by reducing the number and complexity of component parts and/or by improved ease of assembly. Another and related object of the present invention is to provide a dispenser package and method of manufacture having improved visual impact in terms of closely blending the closure structurally and by contour with the design of the package container.

A dispenser package for a fluent product in accordance with one aspect of the present invention includes a plastic container having an axially extending cylindrical neck, and a closure secured to the open end of the neck. The closure includes a plastic fitment having a dispensing opening and a cylindrical wall received within the container neck. Either the container neck or the fitment wall has a radially opening circumferential channel, while the other has a radially projecting circumferential bead received by snap fir into the channel to secure the fitment to the container neck. A top is movably secured to the fitment or to the neck for selectively opening and closing the dispensing opening. In the preferred embodiments of the invention, the dispensing opening is circular, and the top has an annular wall that forms a plug seal within the dispensing opening when the top is in the closed position. The top in the preferred embodiments of the invention is pivotally secured to the fitment or the container neck, and is flush with the fitment or the axial end of the neck in the closed position to form a visually compact structure.

In the preferred embodiments of the invention, the bead is disposed on the closure fitment, and has a frustoconical sidewall for cam-centering the fitment within the neck during assembly of the fitment to the container neck. The neck may also include at least one axial channel, and preferably diametrically opposed axial channels, that extend from the circumferential channel to the open end of the neck. The fitment in accordance with this aspect of the invention includes at least one lug, and preferably diametrically opposed lugs, for receipt in the axial channel(s) as the fitment is inserted into the container neck for circumferentially aligning the fitment with respect to the neck. The top may be integrally molded with the fitment and secured to the fitment by an integral hinge, or may be formed separately from the fitment with spherical lugs that are received within spherical pockets on the container neck or the fitment. In different embodiments of the invention, the fitment may have a radial ledge that overlies a planar edge of the neck, or the fitment may be telescopically entirely received within the container neck so that the top is flush with the axial edge of the container neck in the closed position of the top.

### BRIEF DESCRIPTION OF THE DRAWINGS

The invention, together with additional objects, features and advantages thereof, will be best understood from the following description, the appended claims and the accompanying drawings in which:

FIG. 1 is a perspective view of a dispenser package in accordance with one presently preferred embodiment of the invention;

FIGS. 2 and 3 are fragmentary sectional views of the neck portion of FIG. 1 on an enlarged scale and showing the container closure in the closed and open positions respectively;

FIG. 4 is a fragmentary exploded perspective view of the package illustrated in FIGS. 1-3;

FIG. 5 is a fragmentary exploded perspective view of a dispenser package in accordance with a modified embodiment of the invention;

FIGS. 6 and 7 are fragmentary sectional views on an enlarged scale of the neck portion of the package illustrated in FIG. 5 with the closure in the closed and open positions respectively;

FIG. 8 is a fragmentary exploded perspective view of a dispenser package in accordance with another modified embodiment of the invention; and

FIGS. 9 and 10 are fragmentary sectional views on an enlarged scale of the neck portion of the package in FIG. 8 with the closure in the closed and open positions respectively.

### DETAILED DESCRIPTION OF PREFERRED EMBODIMENTS

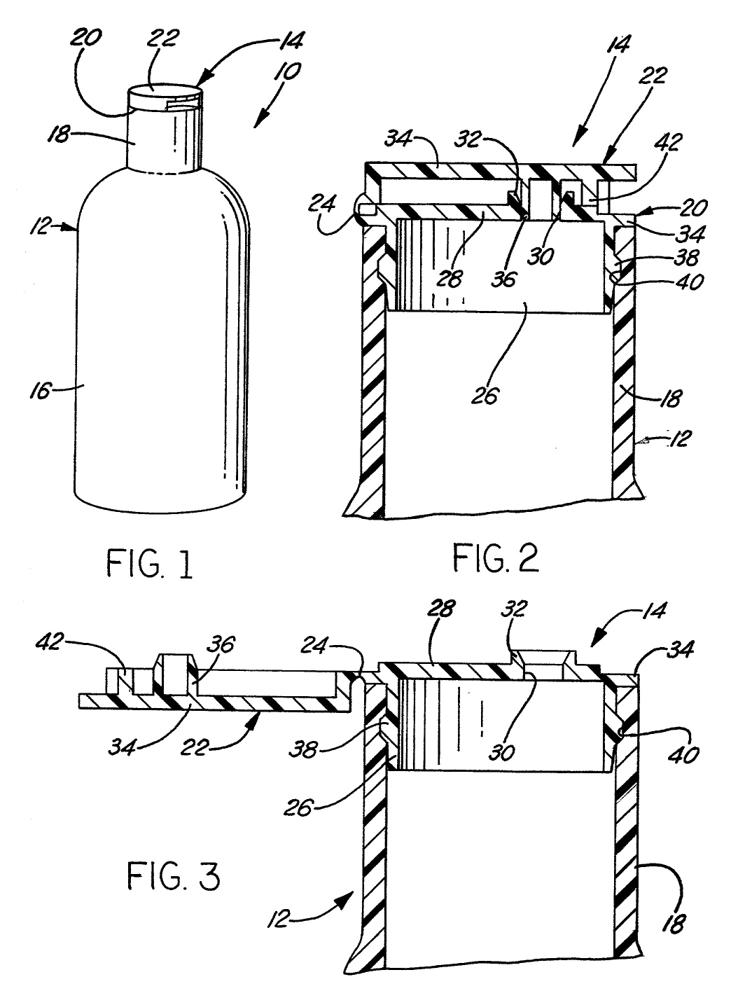

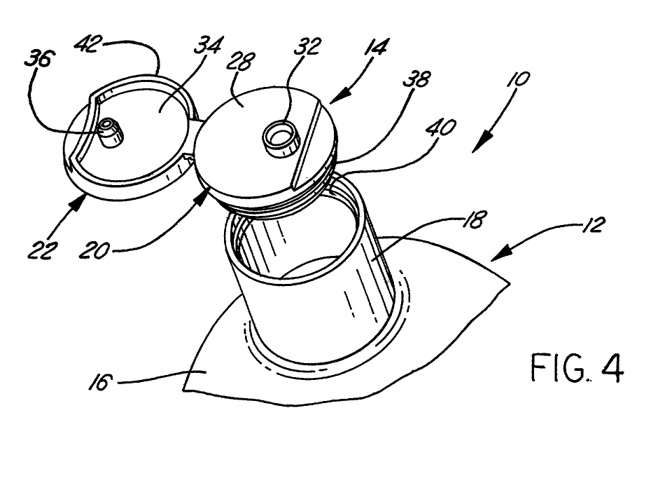

FIGS. 1-4 illustrate a dispenser package 10 in accordance with one presently preferred embodiment of the invention as comprising an integrally molded container 12 to which a closure 14 is secured. Container 12 includes a body 16 from which a cylindrical neck 18 projects. Body 16 and neck 18 may be integrally formed in a blow-molding or other suitable operation from suitable plastic resin composition(s). At least body 16 is preferably of flexible construction for squeezing to dispense the product. In the illustrated embodiment of the invention, container body 16 is of generally cylindrical contour, and neck 18 integrally projects from body 16 coaxially with the body.

Closure 14 in this embodiment of the invention comprises a fitment 20 and a circular top 22 pivotally secured to fitment 20 by an integrally formed hinge 24. Closure 14 is preferably of injection molded plastic construction. Fitment 20 includes a cylindrical wall 26 that is telescopically received within container neck 18. A flat wall 28 on fitment 20 has a circular dispensing opening 30 defined by an axially extending wall 32, and has a radially outwardly projecting ledge 34 that overlies the planar upper edge of neck 18. Top 22 includes a flat wall 34 secured to hinge 24, and an annular wall 36 projecting from flat wall 34 for receipt into dispensing opening 30 in the closed position of the closure (FIGS. 1 and 2) to form a plug seal within opening 30.

Fitment wall 26 has a radially outwardly projecting circumferential bead 38 that is received by snap fit within a circumferentially extending radially inwardly opening channel 40 of complementary contour on the inner surface of container neck 18. Both bead 38 and channel 40 are defined by radially facing cylindrical wall surfaces and opposed frustoconical side surfaces. The lower frustoconical surface of bead 38 (in the orientation of FIG. 2), which is angled upwardly and outwardly, cams the edge of neck 18 radially outwardly as fitment 20 is assembled into neck 18 so as to center the fitment with respect to the neck and facilitate assembly of the fitment to the neck. Hinge 24 preferably comprises a snap-type hinge of conventional construction. A wall 42 extends from flat wall 34 of top 22 for opposed abutment with fitment wall 28 to form a compact low-profile closure structure in the closed position illustrated in FIGS. 1 and 2.

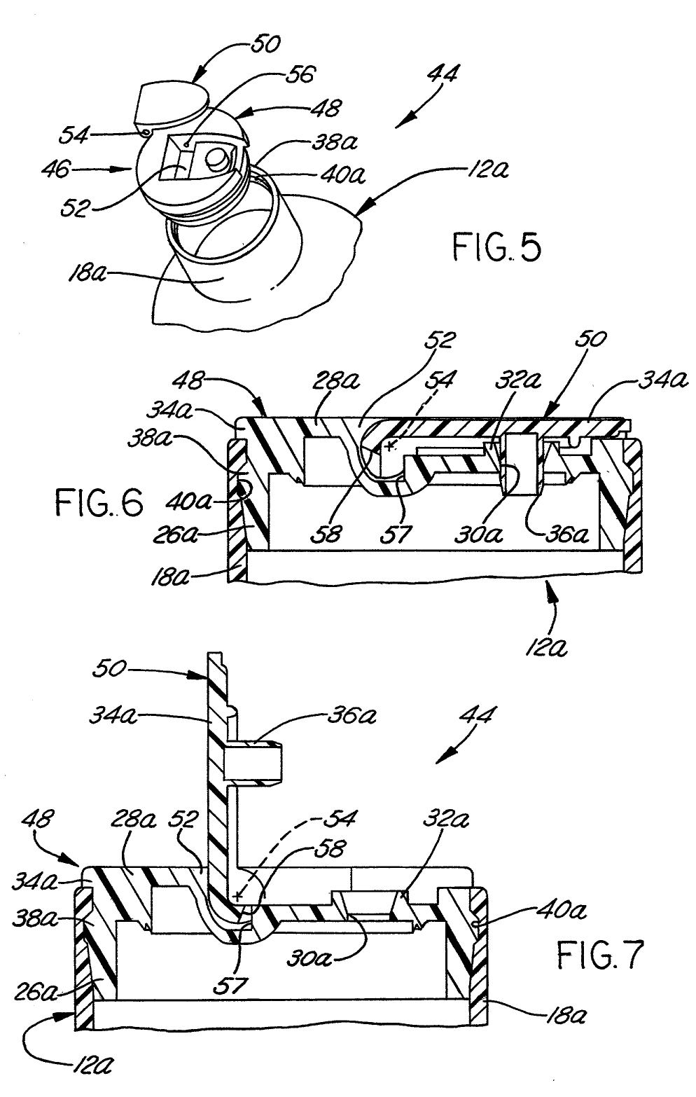

FIGS. 5-7 illustrate a dispenser package 44 in accordance with a modified embodiment of the invention. (Identical or related elements in the various drawings are indicated by identical reference numerals with a letter suffix.) Closure 46 in the embodiment of FIGS. 5-7 includes a fitment 48 and a spade-shaped top 50 formed separately from the fitment. As in the embodiment of FIGS. 1-4, fitment 48 includes a cylindrical wall 26a with a radially outwardly projecting circumferential bead 38a. Container 12a has a cylindrical neck 18a with a corresponding radially inwardly opening circumferential channel 40a. The base wall 28a of fitment 48 includes a dispensing opening 30a defined in part by an annular wall 32a, and has a radially projecting ledge 34a that partially overlies the planar axial edge of neck 18a. Fitment wall 28a also has a recessed pocket 52 that surrounds dispensing opening 30a. Top 50 has a pair of laterally projecting part-spherical nubs 54 that are pivotally received within corresponding part-spherical pockets 56 in fitment pocket 52. Thus, top 50 is freely pivotal about the axis of nubs 54 and pockets 56 between the closed position of FIG. 6 in which top 50 is flush with the top surface of fitment 48, and the fully open position illustrated in FIG. 7 in which top 50 is pivoted away from dispensing opening 30a in order to dispense product. A wall surface 57 within fitment pocket 52 cooperates with an opposing edge 58 of top 50 to function as a stop against opening of top 50 (counterclockwise in FIG. 7).

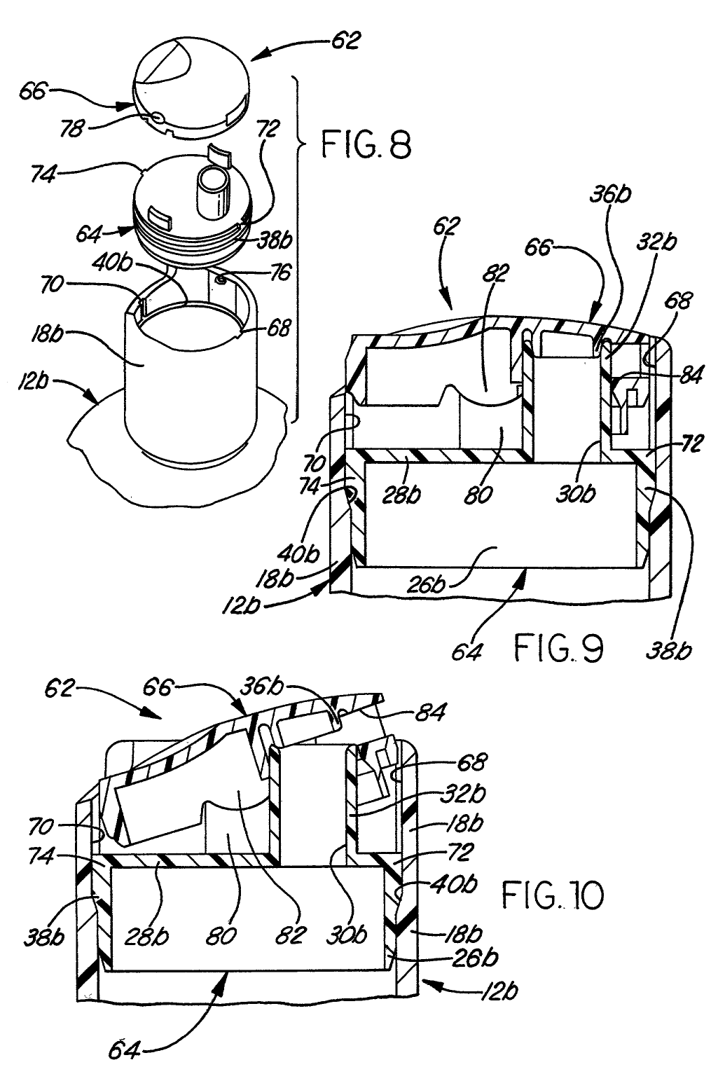

FIGS. 8-10 illustrate a dispenser package 60, in which the closure 62 comprises a fitment 64 and a separately formed disc-shaped top 66. Neck 18b of container 12b has a radially inwardly opening circumferential channel 40b as in the prior embodiments. A pair of diametrically opposed axial channels 68, 70 extend from circumferential channel 40b to the axial edge of neck 18b along the inner surface of the neck. Fitment 64 has a radially outwardly projecting circumferential bead or rib 38b that is received in assembly within channel 40b as in the prior embodiments. Fitment 38b also includes a pair of diametrically opposed nubs 72, 74 that project axially from bead 38b for receipt in axial channels 68, 70 of neck 18b as fitment 64 is assembled to container 12b. These axial nubs and channels align fitment 64 circumferentially with respect to neck 18b. A pair of diametrically opposed part-spherical pockets 76 are formed on the inner surface of neck 18b above channel 40b for receiving a pair of corresponding diametrically opposed part-spherical nubs 78 on disc top 66. Thus, in this embodiment, disc top 66 is pivotally secured to container neck 18b over fitment 64, as distinguished from being pivotally secured to the fitment itself as in the embodiments of FIGS. 1-7. Fitment 64 has a diametrically opposed pair of concave part-circular axial shoulders 80 that pivotally support a pair of convex part-circular bearing ledges 82 on disc top 66. These bearings help support the disc top as it is pivoted between the closed and open positions of FIGS. 9 and 10. When disc top 66 is pivoted to the open position of FIG. 10, plug seal wall 36b of disc top 66 clears annular wall 32b on fitment 64, which partially defines dispensing opening 36b, so that the fluent product within the container may be dispensed through the lateral opening 84 in disc top 66. When disc top 66 returned to the closed position of FIG. 9, opening 84 is beneath the edge of neck 18b, and disc top wall 36b forms a plug seal within dispensing opening 30b. Disc top 66 is generally flush with the upper edge of neck 18b in the closed position.

There have thus been disclosed a dispensing package and method of assembly that fully achieve the objects and aims previously set forth. Several modifications and variations have been disclosed. Other modifications and variations will readily suggest themselves to persons skilled in the art. The invention is intended to encompass all modifications and variations that fall within the spirit and broad scope of the appended claims.

1. A method of making a dispenser package for a fluent product, which comprises the steps of:
(a) integrally molding a plastic container having an axially extending cylindrical neck with an edge and a circumferential channel around an inside surface of said neck spaced from said edge,
(b) providing a plastic fitment having a dispensing opening and a cylindrical wall with a radially outwardly extending bead,
(c) securing said fitment to said neck by inserting said fitment into said neck until said bead snaps into said channel, and
(d) pivotally securing a top to said neck or said fitment for selectively opening and closing said dispensing opening.

2. The method set forth in claim 1 wherein said step (b) includes providing said bead with a frustoconical surface to cam-center said fitment within said neck during said step (c).

3. The method set forth in claim 2 wherein said step (a) comprises providing at least one axial channel in said neck extending from said circumferential channel, and wherein said step (b) comprises providing at least one lug on said fitment for receipt in said axial channel to align said fitment circumferentially with respect to said neck during said step (c).

4. The method set forth in claim 1 wherein said steps (b) and (d) are carried out simultaneously by molding said top integrally with said fitment.

5. The method set forth in claim 1 wherein step (d) is carried out by providing part-spherical nubs on said top, providing part-spherical pockets on one of said neck and said fitment, and snapping said nubs into said pockets.

6. The method set forth in claim 1 wherein said top is provided with an annular wall for plug sealing engagement with said dispensing opening.

7. A method of making a dispenser package for a fluent product, which comprises the steps of:
(a) integrally molding a plastic container having an axially extending cylindrical neck with an edge, a circumferential channel around an inside surface of said neck spaced from said edge, and at least one axial channel extending from said circumferential channel to said edge,
(b) providing a plastic fitment having a dispensing opening and a cylindrical wall with a radially outwardly extending bead, and at least one lug for receipt in said axial channel,
(c) securing said fitment to said neck by inserting said fitment into said neck until said bead snaps into said circumferential channel, receipt of said lug in said axial channel aligning said fitment circumferentially with respect to said neck, and
(d) pivotally securing a top to said neck or said fitment for selectively opening and closing said dispensing opening.

8. The method set forth in claim 7 wherein said step (b) includes providing said bead with a frustoconical surface to cam-center said fitment within said neck during said step (c).

9. The method set forth in claim 7 wherein said steps (b) and (d) are carried out simultaneously by molding said top integrally with said fitment.

10. The method set forth in claim 7 wherein step (d) is carried out by providing part-spherical nubs on said top, providing part-spherical pockets on one of said neck and said fitment, and snapping said nubs into said pockets.

11. The method set forth in claim 7 wherein said top is provided with an annular wall for plug sealing engagement with said dispensing opening.

12. The method set forth in claim 7 wherein said step (b) includes providing a ledge on said fitment that overlies said edge following said step (c).

13. The method set forth in claim 7 wherein said step (a) includes providing diametrically opposed axial channels in said neck, and said step (b) includes providing diametrically opposed lugs on said cylindrical wall that are received in said axial channels in said step (c).

14. A dispenser package for a fluent product, which comprises:
a plastic container having an axially extending cylindrical neck with a radially inner neck surface, a radially outer neck surface, and an axial edge disposed in a plane and extending between said inner and outer neck surfaces,
a fitment of one-piece integrally molded plastic construction having a dispensing opening, a cylindrical wall received within said neck with an outer wall surface opposed to said radially inner neck surface, and a radial ledge overlying said axial edge of said neck and terminating at said outer neck surface,
one of said inner neck surface and said outer wall surface having a radially opening circumferential channel and the other of said inner neck surface and said outer wall surface having a radially projecting circumferential bead received in said channel to secure said fitment to said neck, and
a top movably secured to said fitment or neck for selectively opening and closing said dispensing opening.

15. The package set forth in claim 14 wherein said bead is disposed on said fitment and said channel is disposed on said neck.

16. The package set forth in claim 15 wherein said bead and said channel each have a radially facing base wall and frustoconical sidewalls.

17. The package set forth in claim 14 wherein said neck includes at least one axial channel extending from said circumferential channel to said axial edge, and wherein said fitment has at least one axial lug extending from said bead into said axial channel for aligning said fitment circumferentially with respect to said neck.

18. The package set forth in claim 17 wherein said neck has diametrically opposed axial channels and said fitment has diametrically opposed axial lugs disposed in said channels.
